(19) United States
(12) Patent Application Publication
(10) Pub. No.: US 2011/0184972 A1
(43) Pub. Date: Jul. 28, 2011

(54) SYSTEM AND METHOD FOR NAVIGATING A PRODUCT CATALOG

(75) Inventors: Scott ARD, Pleasanton, CA (US); Adam Goldband, Antioch, CA (US); Daniel Sakai, Los Angeles, CA (US)

(73) Assignee: CBS Interactive Inc., San Francisco, CA (US)

(21) Appl. No.: 12/977,311

(22) Filed: Dec. 23, 2010

Related U.S. Application Data
(60) Provisional application No. 61/289,533, filed on Dec. 23, 2009.

(51) Int. Cl. G06F 17/30

(52) U.S. Cl. 707/769; 707/E17.014

(57) ABSTRACT

A method and apparatus for product catalog navigation. A database stores, in a tangible form, an electronic catalog of product records in an ontology. A query module is configured to receive a product identifier, query the database based on the product identifier and navigate the ontology of the electronic catalog to identify at least one product record in the electronic catalog associated with the product identifier. The product identifier can be image data of the product. The query module can also use supplemental product indicia and additional external information to query the database. Enhanced visualization techniques can be used to display the product in relation to another virtual image.

### RELATED APPLICATION DATA

This application claims priority to U.S. Provisional Application Ser. No. 61/289,533 filed on Dec. 23, 2009, the entire disclosure of which is incorporated herein by reference.

### BACKGROUND

The disclosed embodiments relate to a system and method for navigating an electronic product catalog.

Many websites are configured as online electronic catalogs. These electronic catalogs act as alternatives to traditional paper catalogs and offer enhanced navigational features when compared to their paper counterparts, as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog can allow users to gain information about products they will purchase elsewhere or to make purchases directly from the catalog site itself Additionally, such a catalog opportunities for other parties to purchase advertisements to be displayed to the user.

Electronic catalogs generally store, in a database, information about a number of products which may be anything, such as electronics, housewares, apparel, digital content or any other type of item which may be depicted and/or described electronically. Such items may be described by a taxonomy, which describes the set of products with a set of information that consists of a set of attributes that assume values. That is, each product might be associated with a price, brand, or other attribute. Some attributes would only be stored for some classes of product. For example, weight might be an attribute with respect to laptop computers, but not desktop computers, while both might have a processor speed attribute.

It is known to use Universal Product Code (UPC) to obtain additional information relating to products. For example, U.S. Pat. No. 6,641,037 discloses a system where UPC codes are used to retrieve product information, such as pricing or product reviews, from a computer database.

### BRIEF DESCRIPTION OF THE DRAWINGS

FIG. 1 is a block diagram of components of a computer system in accordance with an embodiment.

FIG. 2 is a diagram illustrating a catalog taxonomy.

FIG. 3 is a screenshot of a catalog product display depicting a front-page for category selection.

FIG. 4 is a screenshot of a catalog in product display depicting a page where the cell phone category has been selected.

FIG. 5 is a screenshot of a catalog product display depicting a page where AT&T™ cell phones have been selected.

FIG. 6 is a screen shot of a main menu of an embodiment.

FIG. 7 is screen shot of a product page of an embodiment

FIG. 8 illustrates the store locator feature.

FIG. 9 illustrates the process of addition of a product to a wish list.

FIG. 10 illustrates the contents of a wish list.

FIG. 11 is a flowchart of a process for navigating a catalog based on product indicia images.

FIG. 12 is a schematic diagram of a computing device of an embodiment.

### DETAILED DESCRIPTION OF THE INVENTION

In the following description, numerous specific details are set forth in order to provide a thorough understanding of embodiments of the invention. It will be apparent, however, to one skilled in the art, that the invention may be practiced without some or all of these specific details.

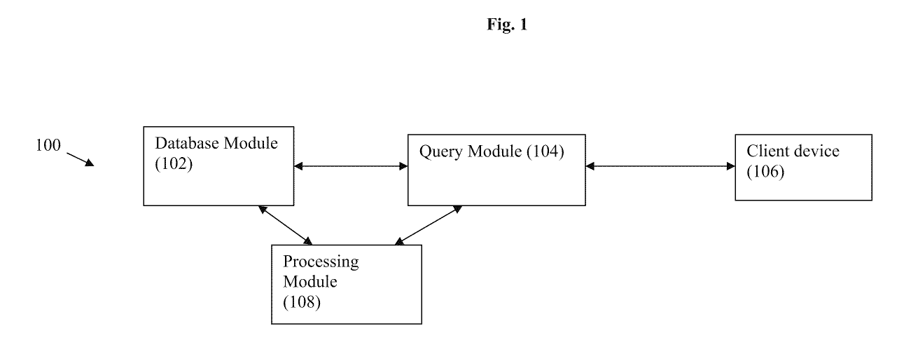

FIG. 1 illustrates system 100. Catalog data is ideally stored in a database module 102. The database may preferably employ a relational model, though it may alternatively employ a flat model, hierarchical model, network model, dimensional model, object model, object-relational model or any combination of the above or other database formats. The database may use a querying language such as SQL to retrieve data internally. The catalog information may be stored on a single machine or on multiple machines over a network. Ideally the catalog is accessible over the Web though a web browser or over another network, but embodiments exist where the catalog is accessible and stored locally on one or more devices. The contents of the catalog may be stored upon any tangible medium, such as, but not limited to: magnetic media, optical media, magneto-optical media, solid-state memory, and/or flash memory. The catalog may be stored locally or distributed over a network. Catalog data may include product specifications, product pricing, product reviews, vendor information or any other data related to a product. Database module 102 also stores information relating to registry lists as described in greater detail below.

Database module 102 receives requests to access the contents of the catalog from query module 104, which mediates requests which are received from the client device 106, which may be a user device such as a PC or mobile device implementing a Web page, or other GUI interface. Database information can then be displayed on client device 106 as set forth below. Processing module 108 communicates with query module 104 and database module 102 to process catalog records as described in greater detail below.

Within the catalog, the taxonomy allows the products to be divided into categories, each of which has subcategories with their own particular set of subcategories. This categorization exists based on the structure of the attributes that are each associated with a given category of product. As an example, in one embodiment, the products could be computers, which are divided into subcategories of laptops and desktops. The laptops can be further subdivided into subcategories, which might include “netbook”, “thin-and-light”, “mainstream”, and “desktop replacement”. Attributes in these subcategories can be weight, price (which might be divided by ranges), and type of processor. On the other hand the desktops might also be have the attributes of price and type of processor, but might have other attributes associated with them, like “form factor” and “number of drive bays”. Moreover, certain attributes might have multi-leveled answers. For example, a processor might be have a processor brand of Intel™, which would then lead to an attribute to differentiate that it was a “Core 2™”, then “Core 2 Duo™” as opposed to “Core 2 Quad™”.

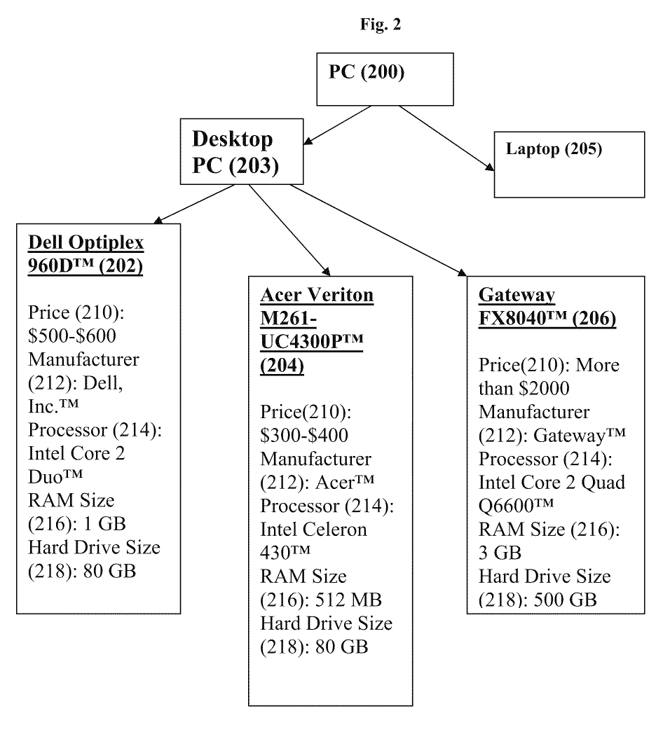

An example taxonomy is presented in FIG. 2, for Desktop PCs. The category of PCs 200 branches into the subcategories of Desktop PCs 203 and Laptop PCs 205. Desktop PCs 203 contain 3 examples of Desktop PCs, Dell Optiplex 960D™ (202) Acer Veriton M261-UC4300P™ (204), and the Gateway FX8040™ (206). Each of these has a value for attributes such as price 210, manufacturer 212, processor 214, RAM size 216, and hard drive size 218. Clearly, the implementation of such a taxonomy will differ by the database model or alternative schema used to store the database in the database module 102. However, given a relational model, such a taxonomy can be stored in one embodiment by associating the products with unique product IDs, then creating tables that associate the IDs with attributes, then creating tables that associate the IDs within the attributes with various values within the taxonomy, in a manner well known in the art to associate pieces of data with information that describes them through relational tables. However, many alternative embodiments are possible and this merely represents a preferred method of storing the catalog if the RDBMS approach is chosen. Also, images or image pattern templates can be stored in association with categories, subcategories and products to facilitate image recognition/matching as discussed in greater detail below.

It is to be noted that the catalog need not represent a set of tangible products represented by nodes within the taxonomy. The catalog may also contain items of digital content. These items may contain digital text, audio, MIDI data, recorded audiobooks, digital music, bitmapped and/or vector graphics, digital photographs, video, movies, TV episodes, digital documents, animations, software, web content, multimedia, any form of encoded or archived data, and/or any other type of file or group of files which may be use to store useful computer data. These files may be stored locally or remotely from the web site or other interface shell which is used to allow the user to access the catalog.

For example, a catalog which contains video content might have attributes such as “length” (which might be various ranges of minutes), “type” (which might be “black-and-white” or “color”, or alternatively might include different levels of color quality), or might involve more qualitative attributes such as “genre” (i.e. action, comedy, drama, science-fiction, western) or “rating” (i.e., some sort of scale such as a star system or a points system). Note that some catalogs will have items in the taxonomy which may reflect pieces of merchandise which are linked to “virtual merchandise”, that is pieces of digital media . . . for example, pieces of digital music might be linked to real-world CD albums on which the songs are located. This may allow the embodiments to make intelligent ad recommendations. For example, if the filter selections (as described below) frequently involve songs from a specific artist, as well as albums that are inexpensive, if the user selects an album or a song from that artist, the embodiment may suggest advertising to the user find inexpensive digital media from that artist that the user would be likely to purchase.

Building upon the catalog, the embodiments allow the products to be accessed through the use of filters. These filters consist of combinations of filter parameters which limit the values. These filter parameters include a set of parameters requiring one or more of: a given attribute equals a specific value; a given attribute is not equal to a specific value; a given attribute is greater than a specific value; a given attribute is greater than or equal to a specific value; a given attribute is less than a specific value; a given category value is less than or equal to a specific value; a given attribute falls within a specific interval; a given category value falls outside of a specific interval, or other variables.

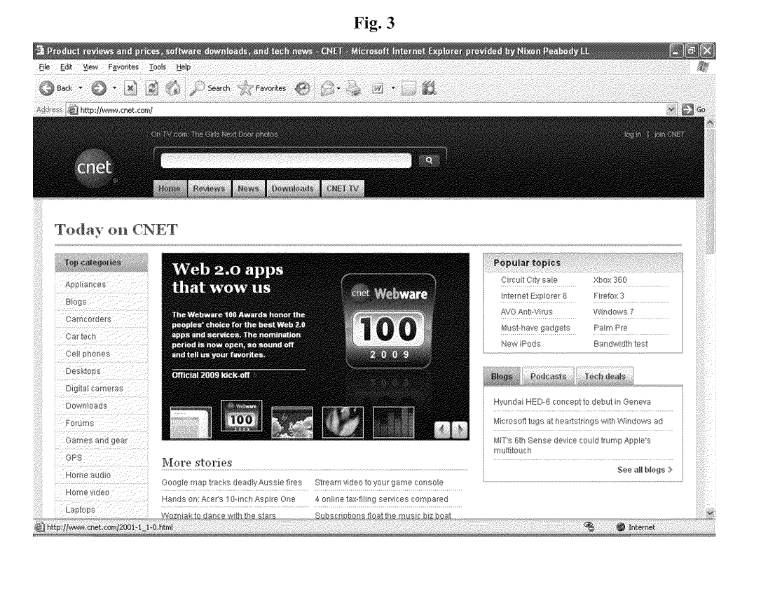

Screenshots illustrating an example of a catalog interface which would contain an assortment of technology products and then progressively use filter parameters to narrow the selection of products which are under consideration and which are displayed in FIG. 3-5. Furthermore, the embodiments record and monitor one or more users' choice of filters over time, providing a pool of data which can then been used as a basis, in combination with a new filter selection, for recommendations of content.

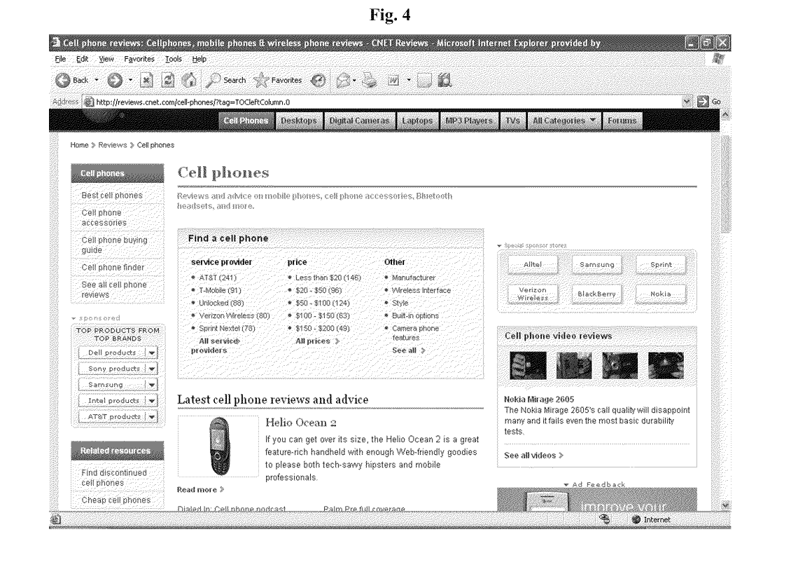

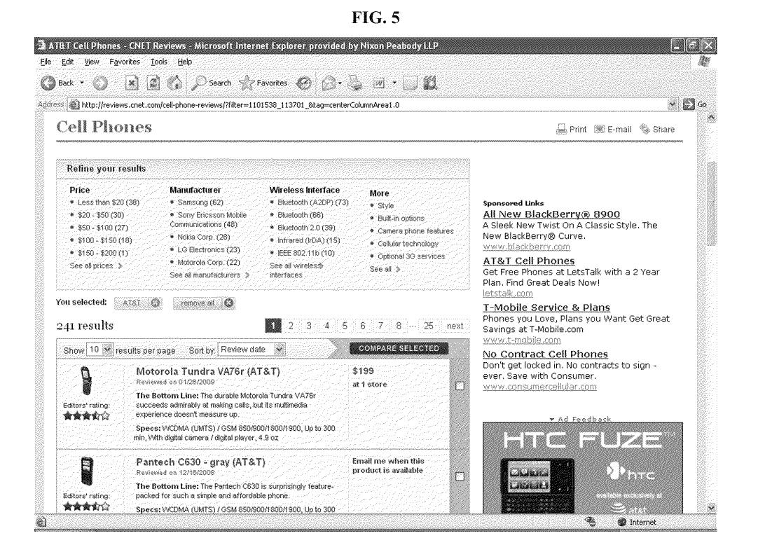

The information shown by the screenshots in FIG. 3-5 is now explained in more detail, as an example of how the user navigates the catalog. FIG. 3 shows a home page of a shopping website, CNET.COM™, which offers access to a catalog of technology products, each of which has multiple attributes associated with it, each of which has a corresponding value. As can be seen in FIG. 3, some of the categories of technology which are in the catalog include “Appliances”, “Cell Phones”, “GPS”, “Laptops”, and many others. When a user clicks on one of these hyperlinks, he or she is brought, for example, to a page as shown in FIG. 4, which would result if the user had chosen the “Cell Phones” category from the homepage in FIG. 3. The catalog then allows the user to navigate from among the many cell phones in the catalog by progressively choosing filter parameters which narrow the selection of cell phones under consideration. Continuing our example, the user might choose that his or her preference was to see cell phones whose service provider was AT&T™. This would restrict consideration by the catalog to the 241 cell phones whose associated service provider is AT&T™. This leads to the resulting display of FIG. 5, which shows the first two phones in an extended list of phones whose service provider is AT&T™. At this point, the set of criteria displays further narrowing filter parameters for selection by the user, such as price, manufacturer, wireless interface, and others. It is to be noted, of course, that this filtration is progressive, i.e. additive. That is, once it has been selected that the service provider is AT&T™, the catalog is designed to reflect, the appropriate filter parameter selection, only those $50-$100 phones that are also designed to have AT&T™ as a service provider. Proceeding onwards, the user may select the additional filter given these two constraints that the manufacturer of the phone is Sony Ericsson Mobile™ communications. Thus, by adding these progressive filters, the search set narrows from hundreds of potential cell phones to 241 AT&T™ cell phones to 27 AT&T™/$50-$100 cell phones to 7 AT&T™/$50-$100/Sony Ericsson Mobile™ cell phones.

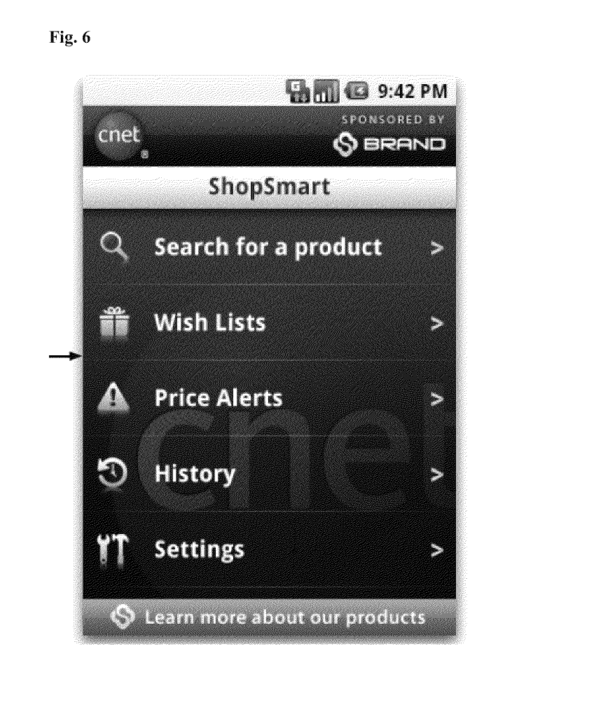

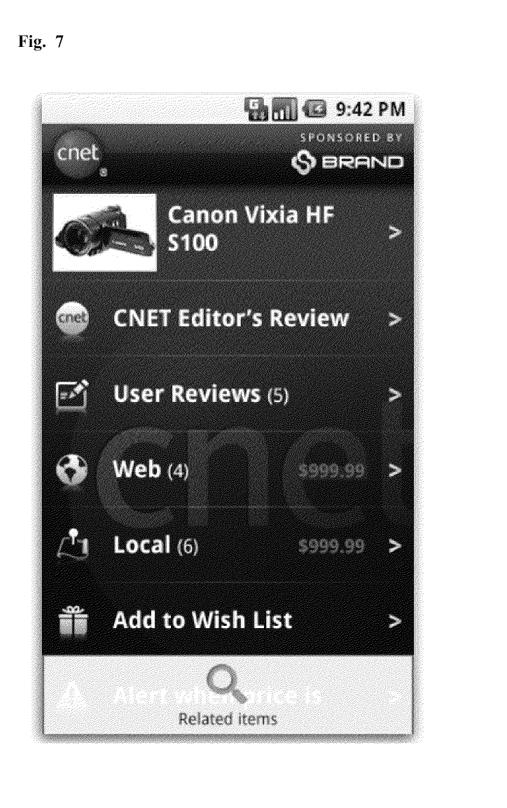

The embodiments described herein integrate a product catalog and other product information with pattern recognition techniques, augmented reality, and registry lists or “wish lists” that are created by users. Users can query the catalog based on a product image, use augmented reality to supplement the catalog data, and share their wish lists with other users to permit the various functionality described below. FIG. 6 depicts a main menu screen of a preferred embodiment. The screens shown herein can be displayed on the interface of a user device, a PC or mobile phone for example. The menu allows a user to search for a product in the catalog, as described above for example. FIG. 7 illustrates a product screen resulting from a user navigating to the product in the catalog. Navigation can be accomplished with filters in the manner described above.

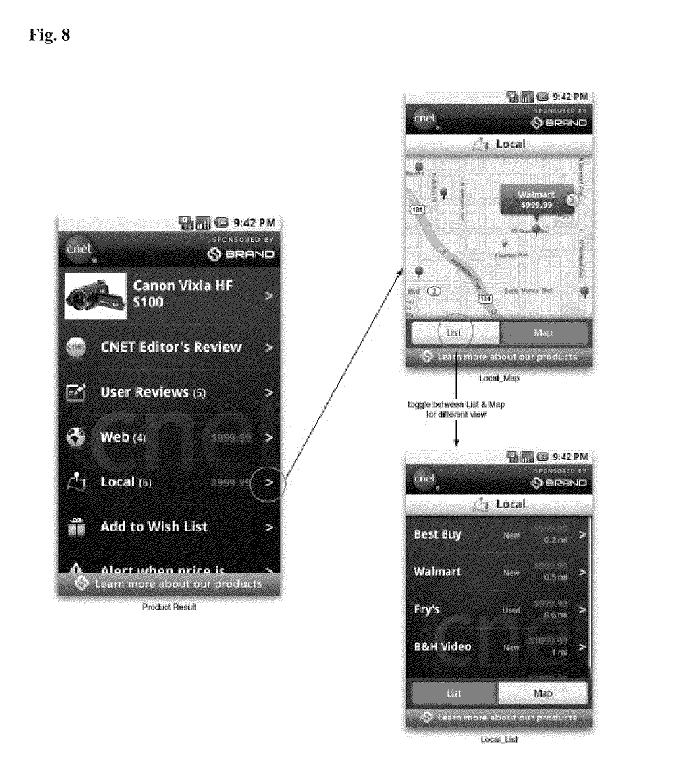

As illustrated in FIG. 8, selection of LOCAL will display location information of nearby vendors, such as stores, where the product can be purchased. The vendor information can be stored in database module 102.

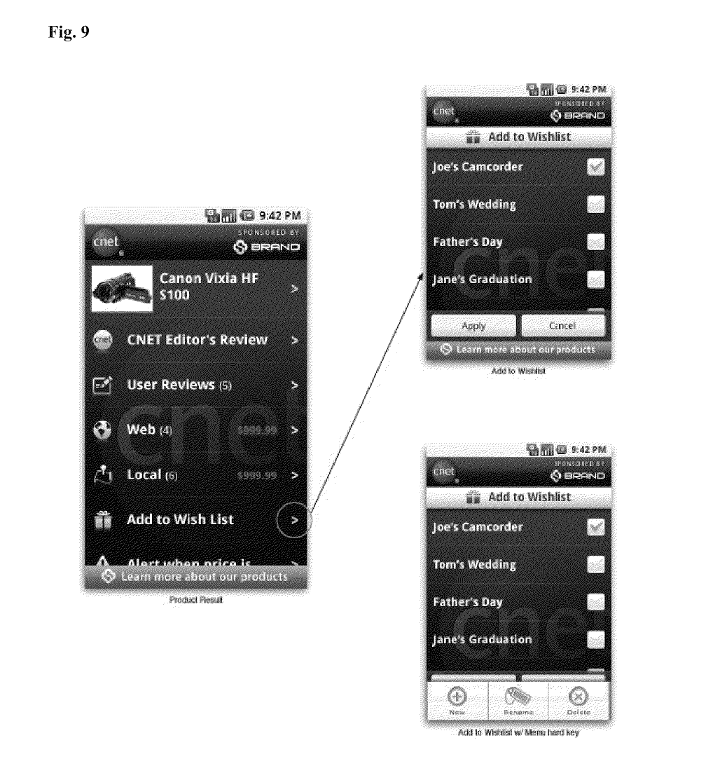

FIG. 9 illustrates the WISH LIST menu choice. Selection of ADD TO WISH LIST will bring up a list of wish lists. The wish lists can be “local”, i.e., be associated with the user of device 106, or “remote”, i.e., be associated with another user. Wish list information can be stored on user device 106 or in database module 102 and thus the terms “local” ad “remote” do not describe where the data is stored but merely are a notation indicating the user associated with the wish list with respect to the user of the device 106 on which the wish list is being displayed. A user can add or remove items to or from a local or remote wish list. However, changes to a remote wish list could be subject to approval by the user associated with the remote wish list.

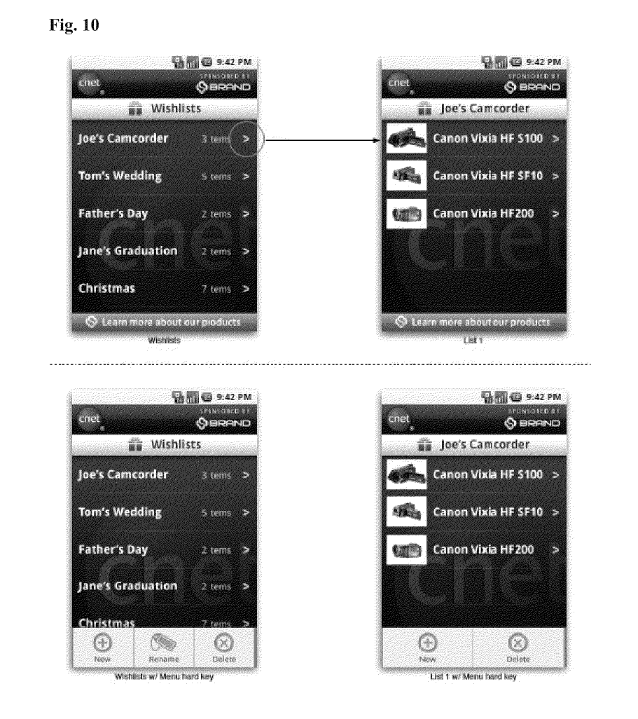

As illustrated in FIG. 10, a wish list is a list of items, such as products, of interest to the user associated with the wish list. When a wish list menu item is selected, the items in the wish list are displayed. In addition to modifying a wish list, a user can take various actions based on the wish list and items in the wish list. For example, a user can synchronize a wish list with a list from another user or from a web site or other entity of a retailer. For example, an online bookstore can create a wish list for fans of science fiction literature and user can add the items of that wish list to a local or remote wish list by selecting the wish list and selecting a SYNCH menu item.

A user can share a wish list with friends to allow the friends to purchase gifts for the user. The friends could use the wish list, as described above, to find pricing and local vendors for the items in the wish list. The friends can remove items from the wish list as they purchase the items. For example, the wish list can be used as a bridal registry and shared with persons invited to a wedding.

A PRICE ALERT menu item can be selected to let a user, or other users with which a wish list is shared, know of a new price of an item, a lower price of an item, or a price exceeding a high or low threshold for an item. An ITEM ALERT menu item can let a user know when a specific item is available in a nearby store based on location data, such as GPS data.

Alternatively, navigation can be accomplished by inputting a UPC for the product or any other product identifier. The UPC can be entered into a user client device 106 by scanning a UPC bar code, typing UPC numbers into a keypad, or in any other manner. For example, when using a mobile device with a camera and an internet connection, the camera would be used to capture the image of the UPC barcode then connects the device's web browser to the corresponding web site catalog. The UPC is sent to query module 104 which queries the catalog and other information in database module 102. UPCs or other unique codes can be associated with product records in the database to permit product location based on the codes.

As noted above, any product identifier can be entered inputted to query module 104 through client device 106. For example, in the case of client device 106 being a mobile phone with camera, or any other imaging device, a user can take a picture of a product to be used as a product identifier for input to query module 104. Image recognition techniques can be used by query module 104 to determine the product or type of product captured in the image. This allows a user to navigate to a product in a catalog merely by taking a picture of the product. Further, various processing can be accomplished based on the product records to produces wish lists, product rankings, similar product listings, allied product listings or complimentary product listings. Techniques disclosed in U.S. Pat. No. 7,698,279 filed on Nov. 10, 2005 and entitled Product Feature and Relationship Comparison System, U.S. application Ser. No. 12/491,078 filed on Jun. 12, 2009 and entitled System And Method For Building A Product, U.S. application Ser. No. 12/827,170 filed on Jun. 30, 2010 and entitled System and Method for Generating an Alternative Product Recommendation, U.S. application Ser. No. 12/613,158 filed on Nov. 5, 2009 and entitled Expandable Product Feature and Relation Comparison System, U.S. Pat. No. 7,783,528 filed on May 6, 2004 and entitled System and Method for Generating an Alternative Product Recommendation, and U.S. Pat. No. 7,627,486 filed on Oct. 7, 2002 and entitled System and Method for Rating Plural Products, the entire disclosures of which are incorporated herein by reference, can be used to determine such allied, complimentary or similar products or to perform other processing on the catalog records.

Supplemental product indicia can be entered to assist in image recognition. For example, a user can enter data into a form presented on client device 106 indicative of the product, for example, that the product is a television, to reduce the complexity of pattern recognition based on the image. The supplemental product indicia is discussed in greater detail below. Further additional data can be entered to assist in navigating the catalog and processing catalog data. For example, a user can enter data into a form presented on client device 106 indicative of, for example, dimensions and conditions of the area in which the image was captured. The additional data is discussed in greater detail below.

Applying image recognition to various applications is known generally. Various environments and programming languages can be used to develop image recognition for products in a catalog and for typical room furnishings, such as beds, chairs, cabinets and the like. Examples of known environments for developing image recognition applications are TINA (Tina is Not an Acronym) and OSTATIC.

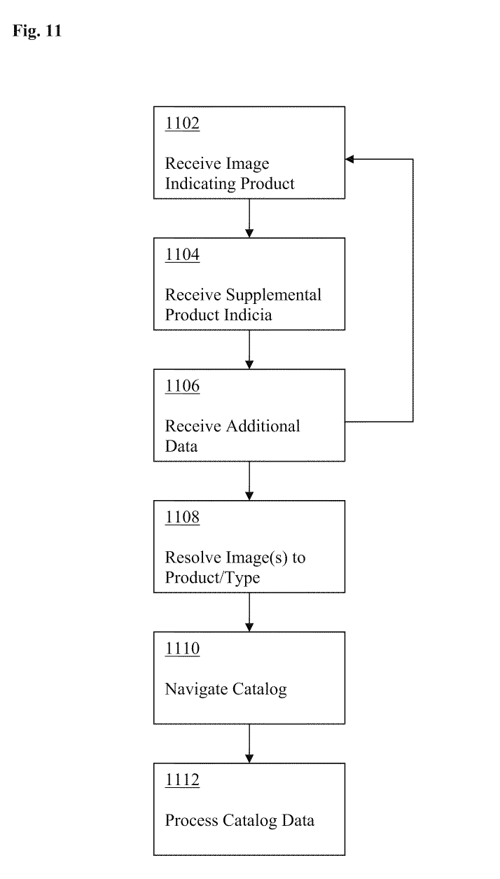

FIG. 11, illustrates an embodiment of a workflow for navigating an electronic catalog. In step 1102, query module 104 receives image data indicating a product. The image data can be captured by client device 106. For example, the image data can represent a picture of a product. As another example, the image data can represent a picture of a place to position the product, such as a cabinet space, a wall area, or a table/countertop.

In step 1104, supplemental product indicia is received by query module 104. As noted above, the supplemental product indicia can be entered by a user through a user interface of client device 106. Supplemental product indicia can be any data that is indicative of the product, such as a type of product (e.g., television), a brand of the product, a model number, a size of the product and the like. The primary purpose of supplemental indicia in this example is to assist in pattern recognition/matching by narrowing the scope of search required by query module 104. For example, if the supplemental product indicia is “TELEVISION”, query module 104 can restrict the query to the television category in the catalog stored in database module 102.

In step 1106, query module 104 receives additional data from client module 106. The additional data can indicate any information external to the product associated with the product identifier, such as dimensions and/or conditions related to the image. For example, the additional data can include the distance of client device 106 from the product or other object during image capture, relative angles of client device with respect to the product or other object, and the like. The additional data can also include information about client device 106 such as imaging resolution or effective lens focal length. Of course such data can also be derived from the identity of client device 106. Accordingly, in place of imaging resolution and effective focal length, and the like, the brand/model number of client device 106 can be used. The primary purpose of the additional data in this example is to facilitate determination of product and room dimensions and object placement as discussed in greater detail below.

Steps 1102, 1104, and 1106 can be reiterated to capture additional image data, supplemental product indicia for the image data, and additional data related to the image, as necessary. For example, in the case of a television, a user might want to capture an image of the existing television, the cabinet or stand supporting the television, placement of chairs in the room, and the like. Each image can be tagged with supplemental product indicia and additional data. Note that not all images will require supplemental product indicia and/or additional data. For example, in the case of desiring a television, when capturing an image of a chair from which a person will view the television, it is not necessary to provide product indicia because the user is not interested in purchasing a chair. The chair can be identified by additional data. However, if the user was interested in buying a chair to view an existing television, supplemental product indicia could be associated with the chair.

In step 1108, known image processing and pattern matching techniques are used, by processing module 108, to resolve the image data to a unique product or type of product. For example, image recognition and pattern matching has been used in machine vision systems for packaging and other manufacturing operations. For example, reference images can be stored in database module 102 in correspondence with product records. The reference image can be a picture of the respective products. The image data received in step 1102 is compared to all, or a subset of, the reference images. Some known pattern matching techniques use grayscale image processing, which assigns 256 levels of gray to each pixel and then recognizes the pattern of the target. More sophisticated algorithms can assign levels of red, green and blue color to each pixel. Also, sub-pixel and normalized correlation methods can be used. Also, pattern matching has been used in the area of image retrieval. Techniques such as those described in Image Database Retrieval Utilizing Affinity Relationships, Mei-Ling Shyu et al., MMDB '03 can be used to correlate the received image to a reference image and thus resolve the received image data to a product.

In step 1110, the catalog is navigated, i.e. one or more product records corresponding to the image are identified. In step 1112, various processes may be carried out based on the product record or records that are identified in step 1110. For example, allied products, supplemental products, or other products that might be of interest can be identified. The processing in step 1112 can be accomplished by processing module 108 and can include any of the processing disclosed in the U.S. Patents and U.S. Patent applications incorporated herein as noted above. For example, the processing of step 1112 can include identifying related or allied products, building a system, identifying alternative products, ranking products or the like.

The embodiments discussed above can be used in connection with techniques for visualizing objects, such as consumer products, using augmented reality techniques as disclosed in U.S. application Ser. No. 12/942,727 entitled Techniques to Visualize Products Using Augmented Reality filed on Nov. 9, 2010, the entire disclosure of which is incorporated herein by reference. For example the catalog data located as a result of step 1110 can be processed by processing module 108, to provide enhanced visualization techniques for creating augmented reality images suitable for online shopping at electronic stores. The augmented reality images may provide visual information such as location, scale or orientation of one virtual object relative to another virtual object. The catalog data can be used to construct the virtual object. For example, size data stored in the catalog can be used for scaling images. Further, other products identified as a result of the processing in step 1112 could be used in an augmented reality shopping system. For example, a user could compare how two comparable but different television look on a wall or how a television and an allied surround sound system would look together.

The virtual objects may comprise digital representations of real objects. For instance, a consumer may capture a digital image of a consumer's real hand, and create an augmented reality image of how a digital image of a cellular telephone may fit within the digital image of the consumer's hand. In this manner, a consumer may visualize how the cellular telephone would fit in a palm of the consumer's hand, a size for the cellular telephone relative to the consumer's hand, whether certain buttons or keys of the cellular telephone can be reached by various fingers of the consumer's hand, how the cellular phone may look at different angles while being held in the consumer's hand, and so forth. As a result, the enhanced visualization techniques may provide greater amounts of visual information about a consumer product to assist a consumer in deciding whether to purchase the consumer product from a physical or electronic store.

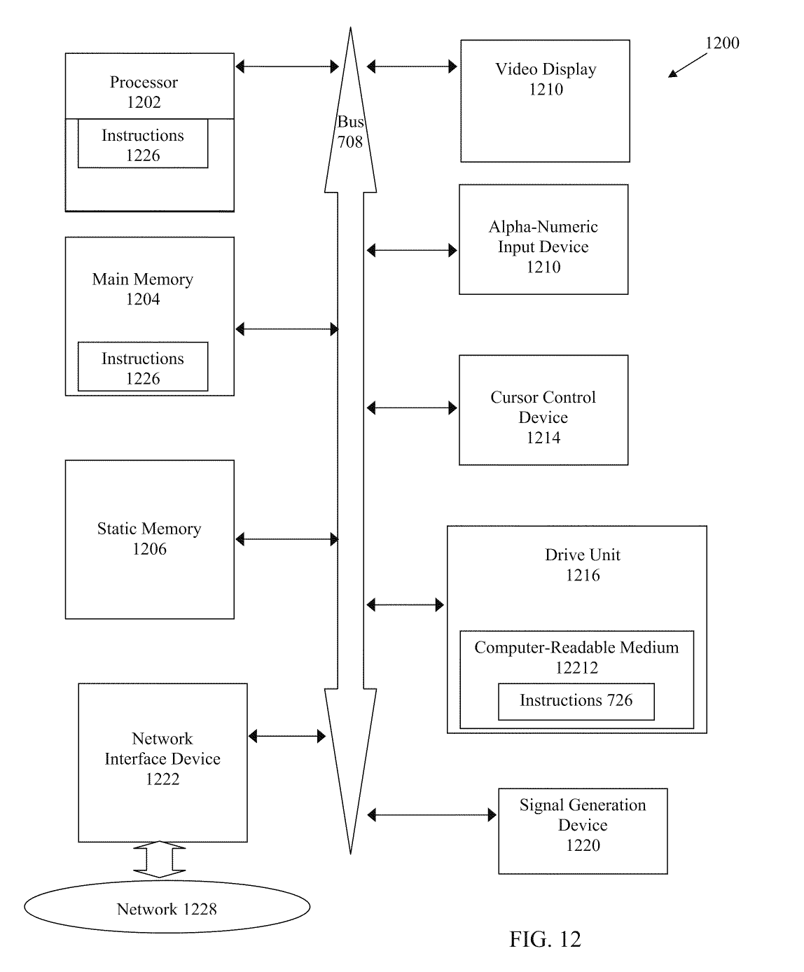

FIG. 12 depicts a diagrammatic representation of a machine in the exemplary form of a computing device 1200 within which a set of instructions, for causing the computing device to perform any one or more of the methodologies discussed herein, may be stored on non-transitory memory and executed. The computing device may operate as a standalone computing device or may be connected (e.g., networked) to other computing devices. If in a network environment, the computing device may operate in the capacity of a server or a client computing device in server-client network environment, or as a peer computing devices in a peer-to-peer (or distributed) network environment. An exemplary computing device includes a personal computer (“PC”), a tablet PC, a set-top box (“STB”), a Personal Digital Assistant (“PDA”), a mobile phone (e.g., a smartphone), a web appliance, a network router, switch or bridge, or any machine capable of executing a set of instructions (sequential or otherwise) that specify actions to be taken by that machine. Further, while only a single computing device is illustrated in FIG. 7, the term “computing device” also includes any collection of computing devices that individually or jointly execute a set (or multiple sets) of instructions to perform any one or more of the methodologies discussed herein.

The exemplary computing device 1200 includes a processor 1202, e.g., a central processing unit (“CPU”), a graphics processing unit (“GPU”) or both, a main memory 1204, which may include read only memory (“ROM”), flash memory, dynamic random access memory (“DRAM”) such as synchronous DRAM (“SDRAM”) or Rambus DRAM (“RDRAM”), etc., and a static memory 1206. The static memory can include a flash memory, static random access memory (“SRAM”), etc., which communicate with each other via a bus 1208. The memory may be non-transitory.

The computing device 1200 may further include a video display unit 1210, such as a liquid crystal display (“LCD”), plasma display device, a field emission device, an electroluminescent device, or a cathode ray tube (“CRT”), just to name a few. The computing device 1200 may also include an alphanumeric input device 1212, such as a keyboard, a cursor control device 1214 (e.g., a mouse), a disk drive unit 1216, a signal generation device 1220, which may include a speaker, and a network interface device 1222.

The disk drive unit 1216 may include a computer-readable medium 1224 on which one or more sets of instructions, such as software 1226, may be stored embodying any one or more of the methodologies or functions described herein. The software 1226 may also reside, completely or at least partially, within the main memory 1204 and/or within the processor 1202 during execution thereof by the computing device 1200, the main memory 1204 and the processor 1202 also constituting computer-readable media. The software 1226 may further be transmitted or received over a network 1228 via the network interface device 1222.

While the computer-readable medium 1224 is shown as a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any tangible and non-transitory medium that is capable of storing, encoding or carrying a set of instructions for execution by the machine and that cause the machine to perform any one or more of the methodologies. The term “computer-readable storage medium” shall accordingly be taken to include, but not be limited to, solid-state memories, and optical and magnetic media.

Embodiments be implemented over any type of communications channel, such as the internet, a local area network (“LAN”), a wide area network (“WAN”), direct computer connections, or the like, using any type of communication hardware and protocols. Any type of hardware or combination of hardware can be used for various clients and servers. Accordingly, the terms “computer”, “computing device”, “computer system” and the like, as used herein, refer to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting assets for purchase. The various information can be stored in any format and thus the term “database” as used herein refers to any collection of information such as a database file, a lookup table, or the like. While the content items may be catalog items, embodiments may be applied to any type of content organized in a hierarchy. For example, embodiments can be applied to various content items in a content management system such as audio content, video content, or textual content.

Moreover, other embodiments will be apparent to those skilled in the art from consideration of the specification and practice of the embodiments disclosed herein. Various aspects and/or components of the described embodiments may be used singly or in any combination. It is intended that the specification and examples be considered as exemplary only.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of non-transitory computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

It should be noted that the system 100 is illustrated and discussed herein as having various modules which perform particular functions and interact with one another. It should be understood that these modules are merely segregated based on their function for the sake of description and do not necessarily represent discrete hardware or software code which is stored on a computer-readable medium for execution on appropriate computing hardware such as a processor. In this regard, these modules, units and other components may be hardware and/or software stored on a computer-readable medium for execution on appropriate computing hardware such as a processor may be thus implemented to substantially perform their particular functions explained herein. The various functions of the different modules and units can be combined or segregated as hardware and/or software stored on a computer-readable medium as above as modules in any manner, and can be used separately or in combination.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

While various embodiments have been described, it is understood that the invention is not limited thereto. The present invention may be changed, modified and further applied by those skilled in the art. Therefore, this invention is not limited to the detail shown and described previously, but also includes all such changes and modifications as defined by the scope of the appended claims.

What is claimed is:

1. An apparatus, comprising:
a processor; and
a memory communicatively coupled to the processor, the memory to store a catalog navigation system for execution by the processor, the catalog navigation system comprising:
a database module that stores, in a tangible form, an electronic catalog of product records in an ontology;
a query module configured to receive a product identifier, query said database module based on the product identifier and identify at least one product record in the electronic catalog associated with the product identifier.

2. An apparatus as recited claim 1, wherein the query module is configured to receive image data of a product as a product identifier.

3. An apparatus as recited in claim 2, wherein the query module is configured to receive supplemental product indicia and query said database module based on the supplemental product indicia and the product identifier.

4. An apparatus as recited in claim 2, wherein the query module is configured to receive additional data indicating factors external to the product associated with the product identifier and query said database module based on the additional data.

5. An apparatus as recited in claim 3, wherein said supplemental product indicia is indicative of at least one of a product category, brand, size, color, and price.

6. An apparatus as recited in claim 4, wherein said additional data is indicative of at least one of a distance between the product and an image capture device producing the image data, an angle of the image capture device with respect to the product, and information about the specifications of the image capture device.

7. An apparatus as recited in claim 2, further comprising a processing module configured to process the at least one product record to determine at least one of a related or allied product, build a system based on plural products, identify alternative products, and rank products.

8. A computer implemented method for navigating a catalog, the method comprising:
receiving, by a computing device, a product identifier;
querying, based on the product identifier, a database that stores, in a tangible form, an electronic catalog of product records in an ontology; and
identifying, by a computing device, at least one product record in the electronic catalog associated with the product identifier.

9. A method as recited claim 8, wherein the product identifier is image data of a product as a product identifier.

10. A method as recited in claim 9, further comprising receiving supplemental product indicia and wherein the querying step comprises querying said database based on the supplemental product indicia and the product identifier.

11. A method as recited in claim 9, further comprising receiving additional data indicating factors external to the product associated with the product identifier and wherein the querying step comprises querying said database based on the additional data and the product identifier.

12. A method as recited in claim 10, wherein said supplemental product indicia is indicative of at least one of a product category, brand, size, color, and price.

13. A method as recited in claim 11, wherein said additional data is indicative of at least one of a distance between the product and an image capture device producing the image data, an angle of the image capture device with respect to the product, and information about the specifications of the image capture device.

14. A method as recited in claim 9, further comprising processing the at least one product record to determine at least one of a related or allied product, build a system based on plural products, identify alternative products, and rank products.

15. Computer readable media having computer readable instructions recorded therein which, when executed by a processor cause the processor to carry out a method for navigating a catalog, the method comprising:
receiving, by a computing device, a product identifier;
querying, based on the product identifier, a database that stores, in a tangible form, an electronic catalog of product records in an ontology; and
identifying, by a computing device, at least one product record in the electronic catalog associated with the product identifier.

16. Media as recited claim 15, wherein the product identifier is image data of a product as a product identifier.

17. Media as recited in claim 16, the method further comprising receiving supplemental product indicia and wherein the querying step comprises querying said database based on the supplemental product indicia and the product identifier.

18. Media as recited in claim 16, the method further comprising receiving additional data indicating factors external to the product associated with the product identifier and wherein the querying step comprises querying said database based on the additional data and the product identifier.

19. Media as recited in claim 17, wherein said supplemental product indicia is indicative of at least one of a product category, brand, size, color, and price.

20. Media as recited in claim 18, wherein said additional data is indicative of at least one of a distance between the product and an image capture device producing the image data, an angle of the image capture device with respect to the product, and information about the specifications of the image capture device.

21. Media as recited in claim 16, the method further comprising processing the at least one product record to determine at least one of a related or allied product, build a system based on plural products, identify alternative products, and rank products.

22. An apparatus as recited in claim 2, further comprising a processing module configured to process the at least one product record to determine at least one related image, the processing module also being configured to generate display data of the image data in correspondence with the at least one related image based on the at least one product record.

23. A method as recited in claim 9, further comprising processing the at least one product record to determine at least one related image and generating display data of the image data in correspondence with the at least one related image based on the at least one product record.

24. Media as recited in claim 16, the method further comprising processing the at least one product record to determine at least one related image and generating display data of the image data in correspondence with the at least one related image based on the at least one product record.
